(19) United States
(12) Patent Application Publication
(10) Pub. No.: US 2007/0077905 A1
(43) Pub. Date: Apr. 5, 2007

(54) QUADRATURE VOLTAGE CONTROLLED OSCILLATOR

(75) Inventors: Seung Min OH, KYUNGKI-DO (KR); Won Jin BAEK, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/469,274

(22) Filed: Aug. 31, 2006

(30) Foreign Application Priority Data
Sep. 15, 2005 (KR) 10-2005-0086519

(51) Int. Cl. H04B 1/40; H04B 1/06

(52) U.S. Cl. 455/264; 455/76

(57) ABSTRACT

In a quadrature voltage controlled oscillator, a first oscillator includes a first resonant circuit for generating a preset first resonant frequency and a first pair of cross-coupled transistors for supplying energy to the first resonant frequency to generate first and second signals having a phase difference of 180°. A second oscillator includes a second resonant circuit for generating a preset second resonant frequency and a second pair of cross-coupled transistors for generating third and fourth signals for supplying energy to the second resonant frequency having a phase difference of 180°. A first current source is connected between a first common node of the first cross-coupled transistor pair and a ground. A second current source is connected between a second common node of the second cross-coupled transistor pair and the ground. A differential load is connected between a third common node of the first and second current sources and the ground.

### CLAIM OF PRIORITY

This application claims the benefit of Korean Patent Application No. 2005-86519 filed on Sep. 15, 2005 in the Korean Intellectual Property Office, the disclosure of which is incorporated herein by reference.

### BACKGROUND OF THE INVENTION

1. Field of the Invention

The present invention relates to a quadrature voltage controlled oscillator employed in an RF transceiver which performs quadrature modulation/demodulation. More particularly, the present invention relates to a quadrature voltage controlled oscillator which has a common node configured as an inductor to differentiate a quadrature signal without using an active device, thereby achieving improved phase noise properties and reduced power consumption.

2. Description of the Related Art

A demand for wireless communications has risen worldwide over the recent years. But a limited available frequency is driving up licensing costs for a specific frequency. Accordingly, companies and related organizations have sought for more complicated modulation to enhance efficiency in frequency use. Also, such a limited frequency has led to a call for higher frequency, and Radio Frequency integrated Circuits (RFIC) which can process the higher frequency.

Here, the highest data rate processable by RF is determined by a modulation method, typically, Quadrature Amplitude Modulation (QAM) (used in CATV) which ensures highest efficiency in frequency use. The QAM system is characterized by two different signal waveforms in the same frequency and a phase difference of 90 degree between the signals.

One of the signals is generally termed an In-Phase (I) signal and the other one is termed a Quadrature-Phase (Q) signal. The I/Q signals are typically modulated and demodulated by a signal generated from a Voltage Controlled Oscillator (VCO).

Meanwhile, a frequency is down-converted in an RF receiver. At this time, phase noise of the VCO is a crucial factor for determining capability of the receiver. Furthermore, recently the receiver has been required to achieve integration, miniaturization and lower power consumption, and also I/Q signals for increasing data speed.

A method for generating the I/Q signals is largely classified into coupling and injection methods depending on phase shifting. Also, the I/Q signal generation method is broken down into active and passive methods depending on use of an active device.

Specifically, first, in case of employing a VCO and a frequency distributor, a duty cycle of the VCO less than 50% renders the I/Q signals inaccurate. Here, typically loads of the frequency distributor act as resistances, which however are so differently sized that the accuracy of the IQ signals is compromised.

Second, in case of employing a VCO and a multi-phase filter, an amplifier is necessarily added due to significant signal loss, thereby resulting in great additional power consumption.

Third, in case of employing two separate VCOs and coupling, a coupling transistor is utilized to couple the VCOs, thereby increasing phase noises.

A conventional quadrature voltage controlled oscillator based on an injection method will be explained with reference to FIG. 1.

FIG. 1 is a circuit diagram illustrating the conventional quadrature voltage controlled oscillator.

The conventional quadruture voltage controlled oscillator shown in FIG. 1 is a differential cross-coupled LC-tuned voltage controlled oscillator. The voltage controlled oscillator includes a first oscillator 10, a second oscillator 20, a transformer 30 and a current source 40. The first oscillator 10 generates first and second signals V1 and V2 having a phase difference of 180 degree. The second oscillator 20 generates third and fourth signals V3 and V4 having a phase difference of 180 degree. The transformer 30 includes two coils Ls1 and Ls2 by which the first and second signals V1 and V2 and the third and fourth signals V3 and V4 perform magnetic induction coupling in the out-of-phase relation. The transformer 30 maintains a preset phase difference between the coils Ls1 and Ls2. The current source 40 is commonly connected to the transformer and grounded.

The voltage controlled oscillator includes first and second grounded capacitors Cs1 and Cs2 which are connected to the coils Ls1 and Ls2 of the transformer 30, respectively. Also, the first and second capacitors Cs1 and Cs2 enable injection through bigger impedance.

Such a quadrature voltage controlled oscillator is disclosed in detail in U.S. Pat. No. 6,911,870.

In the conventional quadruture voltage controlled oscillator, the coils Ls1 and Ls2 are coupled to and injection-locked with voltages Vs1 and Vs2 each having a frequency twice an output frequency of each of the oscillators in order to generate a quadrature signal. This improves phase noise properties and obviates a need for an additional active device.

However, disadvantageously, the coils Ls1 and Ls2 need to be integrated inside an IC of the conventional quadrature voltage controlled oscillator.

### SUMMARY OF THE INVENTION

The present invention has been made to solve the foregoing problems of the prior art and therefore an object according to certain embodiments of the present invention is to provide a quadrature voltage controlled oscillator employed in an RF transceiver which performs quadrauture modulation/demodulation, and has a common node configured as an inductor to differentiate a quadrature signal without requiring an active device, thereby achieving improved phase noise properties and reduced power consumption.

According to an aspect of the invention for realizing the object, there is provided a quadrature voltage controlled oscillator including a first oscillator including a first resonant circuit for generating a preset first resonant frequency and a first pair of cross-coupled transistors for supplying energy to the first resonant frequency to generate first and second signals having a phase difference of 180 degree; a second oscillator including a second resonant circuit for generating a preset second resonant frequency and a second pair of cross-coupled transistors for supplying energy to the second resonant frequency to generate third and fourth signals having a phase difference of 180 degree; a first current source connected between a first common node of the first cross-coupled transistor pair and a ground; a second current source connected between a second common node of the second cross-coupled transistor pair and the ground; and a differential load connected between a third common node of the first and second current sources and the ground.

The first resonant circuit includes a first inductor part including two inductors each having first and second ends, the first ends connected in parallel to a supply voltage terminal; and a first capacitor part for supplying capacitance in response to a first controlled voltage and cooperating with the first inductor part to generate the first resonant frequency, the first capacitor connected to the second ends of the respective inductors of the first inductor part.

Here, the first current source comprises a Metal Oxide Semiconductor (MOS) transistor having a gate for receiving a first control signal, a drain connected to the first common node and a source connected to the third common node, the MOS transistor controlling current flowing between the drain and the source in response to the first control signal.

The second resonant circuit includes a second inductor part including two inductors each having first and second ends, the first ends connected in parallel to a supply voltage terminal; and a second capacitor part for supplying capacitance in response to a second control voltage and cooperating with the second inductor part to generate the second resonant frequency, the second capacitor connected to the second ends of the respective inductors of the second inductor part.

Here, the second current source comprises an MOS transistor having a gate for receiving a second control signal, a drain connected to the second common node and a source connected to the third common node, the MOS transistor controlling current flowing between the drain and source in response to the second control signal.

The differential load comprises an inductor for inducing an alternating current.

The first and second signals of the first oscillator have a phase difference of 90 degree with respect to the third and fourth signals of the second oscillator, respectively.

The first current source further includes a resistor connected to the gate of the MOS transistor.

The second current source further comprises a resistor connected to the gate of the MOS transistor.

The first capacitor part comprises two capacitors connected in series to the second ends of the respective inductors of the first inductor part, wherein the capacitors of the first capacitor part supply capacitance which is variable according to the first control voltage.

The second capacitor comprises two capacitors connected in series to the other ends of the respective inductors of the second inductor part, wherein the capacitors of the capacitor part supply capacitance which is variable according to the second control voltage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram illustrating a conventional quadrature voltage controlled oscillator;

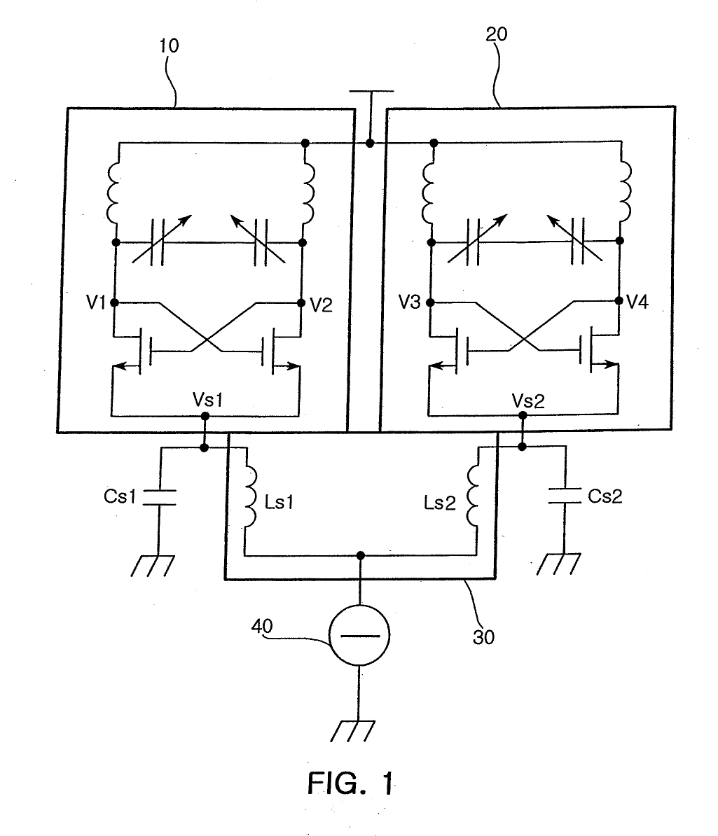

FIG. 2 is a circuit diagram illustrating a quadrature voltage controlled oscillator according to the invention;

FIG. 3 is a circuit diagram illustrating first and second current sources of FIG. 2; and

FIG. 4 is a waveform diagram illustrating a quadrature signal of FIG. 2.

### DETAILED DESCRIPTION OF THE PREFERRED EMBODIMENT

Preferred embodiments of the present invention will now be described in detail with reference to the accompanying drawings, in which the same reference numerals are used throughout the different drawings to designate the same or similar components.

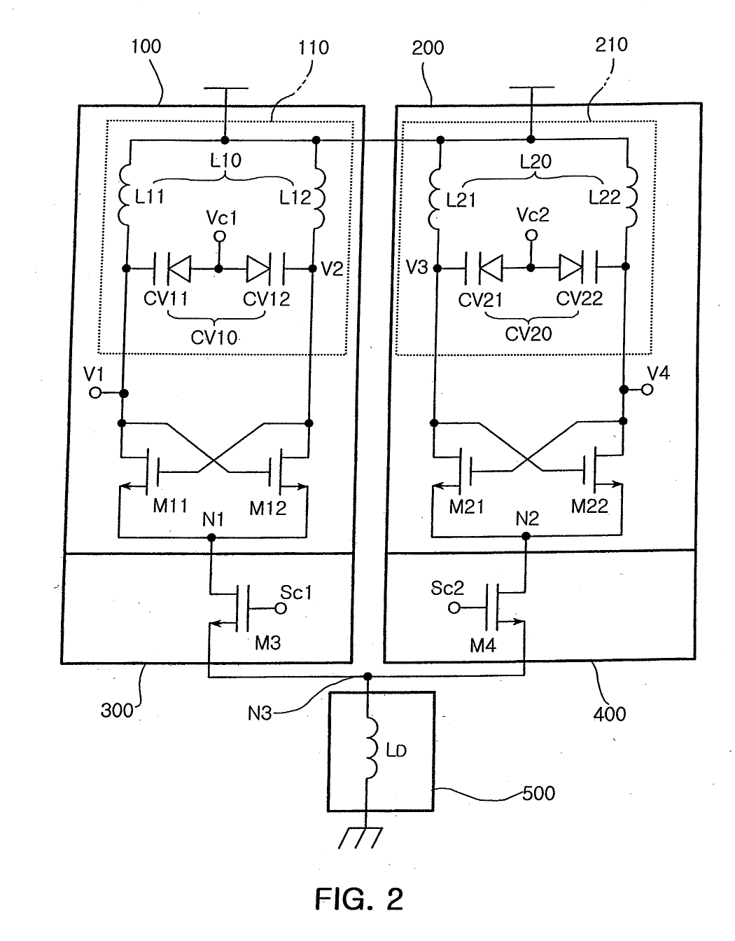

FIG. 2 is a circuit diagram illustrating a quadrature voltage controlled oscillator of the invention.

Referring to FIG.2, the quadrature voltage controlled oscillator of the invention includes a first oscillator 100, a second oscillator 200, a first current source 300, a second current source 400 and a differential load 500.

The first oscillator 100 includes a first resonant circuit 110 for generating a preset first resonant frequency and a pair of first cross-coupled transistors M11 and M12 for supplying energy to the first resonant frequency to generate first and second signals V1 and V2 having a phase difference of 180 degree.

The second oscillator 200 includes a second resonant circuit 210 for generating a preset second resonant frequency and a second pair of cross-coupled transistors M21 and M22 for supplying energy to the second resonant frequency to generate third and fourth signals V3 and V4 having a phase difference of 180 degree.

The first current source 300 is connected between a first common node N1 of the first cross-coupled transistor pair M11 and M12 and a ground, and the second current source 400 is connected between a second common node N2 of the second cross-coupled transistor pair M21 and M22 and the ground.

The differential load 500 is connected between a third common node N3 of the first and second current sources 300 and 400 and the ground. For example, the differential load 500 may be structured as an inductor for inducing an alternating current.

Also, the first and second signals of the first oscillator 100 have a phase difference of 90 degree with respect to the third and fourth signals of the second oscillator 200, respectively.

Specifically, the first resonant circuit 110 includes a first inductor part L10 and a first capacitor part CV10. The first inductor part L10 includes two inductors L11 and L12 each having first and second ends. The first ends of the inductors L11 and L12 are connected in parallel to a supply voltage terminal Vdd. The first capacitor CV10 is connected to the second ends of the respective inductors L11 and L12 of the first inductor part L10. The first capacitor CV10 supplies capacitance in response to a first control voltage VC1 and cooperates with the first inductor L10 to generate the first resonant frequency.

Here, the first current source 300 is configured as a Metal Oxide Semiconductor (MOS) transistor having a gate for receiving a first control signal, a drain connected to the first common node N1, and a source connected to the third common node N3. The MOS transistor controls current flowing through the drain and the source in response to the first control signal.

Furthermore, the first capacitor part CV10 includes two capacitors CV11 and CV12 connected in series to the second ends of the respective inductors L11 and L12 of the first inductor part L10. The two capacitors CV11 and CV12 of the first capacitor part CV10 supply capacitance which is variable according to a first control voltage VC1. Here, the capacitors CV11 and CV12 are structured as a variable capacitance device such as a varactor diode.

Moreover, specifically, the second resonant circuit 210 includes a second inductor part L20 and a second capacitor CV20. The second inductor part L20 includes two inductors L21 and L22 each having first and second ends. The first ends of the inductors are connected in parallel to the supply power Vdd. The second capacitor CV20 is connected to the second ends of the respective inductors L21 and L22 of the second inductor part L20. The second capacitor CV20 supplies capacitance in response to a second control voltage VC2 and cooperates with the second inductor part L20 to generate the second resonant frequency.

The second current source 400 is configured as an MOS transistor having a gate for receiving a second control signal, a drain connected to the second common node N2 and a source connected to the third common node N3. The MOS transistor controls current flowing between the drain and the source in response to the second control signal.

The second capacitor part CV20 includes two capacitors CV21 and CV22 each connected in series to the second ends of the respective inductors L21 and L22 of the second inductor part L20. The capacitors CV21 and CV22 of the second capacitor part CV20 supply capacitance which is variable according to the second control voltage VC2. Here, the capacitors CV21 and CV22 are structured as a variable capacitance device such as a varactor diode.

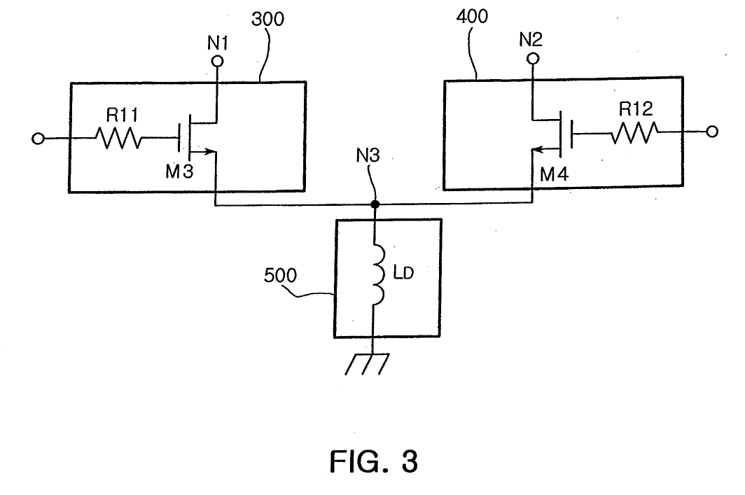

FIG. 3 is a circuit diagram illustrating the first and second current sources of FIG. 2.

Referring to FIG. 3, the first current source 300 further includes a resistor R11 connected to a gate terminal of the MOS transistor M3. Likewise, the second current source 400 further includes a resistor R21 connected to a gate terminal of the MOS transistor M4.

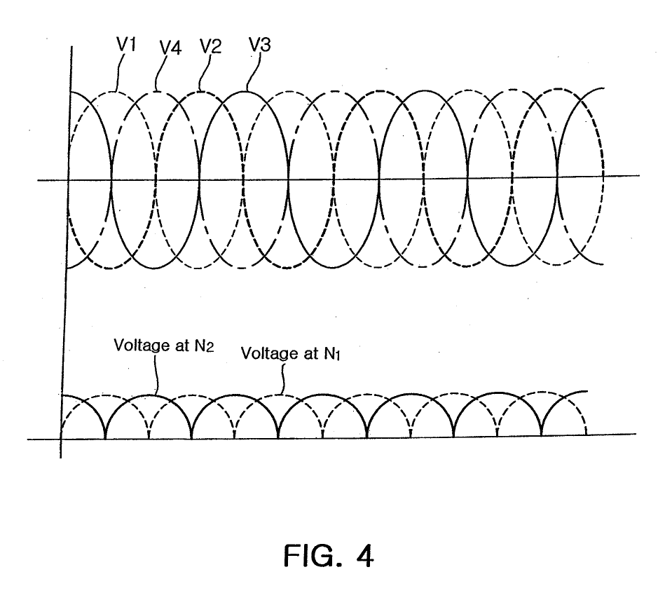

FIG. 4 is a waveform diagram illustrating the quadrature signal of FIG. 2. Referring to FIG. 4, V1 and V2 denote the first and second signals generated from the first oscillator 100, respectively. The first and second signals V1 and V2 are 180 degree out of phase with each other as described above. V3 and V4 denote the third and fourth signals generated from the second oscillator 200. The third and forth signals V3 and V4 are also 180 degree out of phase with each other. The first and third signals V1 and V3 have a phase difference of 90 degree and the second and fourth signals V2 and V4 have a phase difference of 90 degree. Accordingly, the first to fourth signals V1 to V4 are a quadrature signal.

When the first and second signals V1 and V2 are assumed to be an I signal, the third and fourth signals V3 and V4 are a Q signal, and vise versa.

The operations and effects of the invention will be explained in detain with reference to the accompanying drawings.

The quadrature voltage controlled oscillator of the invention differentiates a quadrature signal using an inductor, thereby not generating phase noises and more ensuring the quadrature signal to be differential. A detailed explanation will be given with reference to FIGS. 2 to 4.

Referring to FIG. 2, first, the first oscillator 100 of the quadrature voltage controlled oscillator of the invention generates first and second signals V1 and V2 which are 180 degree out of phase with each other. In further explanations, the first resonant circuit 110 of the first oscillator 100 generates the preset first resonant frequency. At the same time, the first resonant frequency is oscillated when supplied with energy by the first cross-coupled transistor pair M11 and M12. Also, the first cross-coupled transistor pair M11 and M12 generates the first and second signals V1 and V2 which are 180 degree out of phase with each other.

In the first oscillator 100, the preset frequency is resonated by inductance of the first inductor part L10 of the first resonant circuit 110 and capacitance of the first capacitor part CV10 of the first resonant circuit 110. Here, in a case where the capacitors of the first capacitor part CV10 are structured as a variable capacitance device such as a varactor diode, the capacitance of the tunable capacitance device can be varied by a control voltage to vary the resonant frequency into a desired frequency.

The first current source 300 of the invention is connected between the first common node N1 of the first cross-coupled transistor pair M11 and M12 and the ground. This allows current to flow constantly in the first cross-coupled transistor pair M11 and M12 of the first oscillator 100, thereby stabilizing oscillation of the first oscillator 100.

In addition, in a case where the first current source 300 is configured as an MOS transistor, the first control signal Sc1 is supplied to the gate of the MOS transistor, thereby controlling current between the drain and source of the MOS transistor.

At the same time, the second oscillator 200 of the quadrature voltage controlled oscillator of the invention generates the third and fourth signals V3 and V4 which are 180 degree out of phase with each other. In further explanations, the second resonant circuit 210 of the second oscillator 200 generates the preset first resonant frequency. At the same time, the second resonant frequency is oscillated when supplied with energy by the second cross-coupled transistor M21 and M22. Also, the second cross-coupled transistor pair M11 and M12 generates the third and fourth signals V3 and V4 which are 180 degree out of phase with each other.

In the second oscillator 200, the preset frequency is resonated by inductance of the second inductor part L20 of the second resonant circuit 210 and capacitance of the second capacitor part CV20 of the second resonant circuit 210. Here, in a case where the capacitors of the second capacitor part CV20 are configured as a varactor diode, capacitance of the variable capacitance device is varied by a controlled voltage to vary the resonant frequency into a desired frequency.

The second current source 400 functions similarly to the first current source 300. That is, the second current source 400 of the invention is connected to the second common node N2 of the second cross-coupled transistor pair M21 and M22 and the ground. This allows current to flow constantly in the second cross-coupled transistor pair M21 and M22 of the second oscillator 200, thereby stabilizing oscillation of the second oscillator 200.

Also, in a case where the second current source 400 is configured as an MOS transistor, a second control signal Sc2 is applied to the gate of the MOS transistor, thereby controlling current between the drain and source of the MOS transistor.

Moreover, the differential load 500 is connected between the third common node N3 of the first current source 300 and the second current source 400 and the ground. The differential load 500 differentiates the first and second current sources 300 and 400 so that the first to fourth signals are assured to be a quadrature signal.

In this fashion, the quadrature voltage controlled oscillator of the invention includes first and second oscillators 100 and 200, and a differential load 500 connected to the common node of the first and second current sources 300 and 400 of the two independent oscillators 100 and 200. Here, the independent oscillators 100 and 200 can apply I/Q signals only when the first common node N1 and the second common node N2 are differential. First, two oscillators 100 and 200 each generate differential signals V1, V2, V3 and V4.

Here, the first and second common nodes N1 and N2 have frequency components twice the first to fourth signals V1, V2, V3 and V4 due to push-push operation of a differential amplifier. However, without coupling between the two common nodes N1 and N2, signals at the first and second common nodes N1 and N2 cannot be differential from each other, and thereby I/Q signals cannot be produced in the oscillators.

However, as shown in FIG. 2, the invention employs an inductor for inducing an alternating current, thereby allowing signals at the common nodes N1 and N2 to be differential from each other.

Meanwhile, referring to FIG. 3, the resistors R11 and R12 are connected to the respective gates of the MOS transistors M3 and M4 in the first and second current sources 300 and 400. The resistors R11 and R12 further ensure the MOS transistors M3 and M4 are differential from each other. This is because without the resistors in the MOS transistors M3 and M4, the gates of the MOS transistors M3 and M4 may be DC-biased and AC-grounded as well. This prevents the MOS transistors M3 and M4 from operating differentially. In the end, the first and second common nodes N1 and N2 cannot be differential from each other.

Therefore, according to the invention, the resistors connected to the gate of the MOS transistors M3 and M4 further ensure the MOS transistors M3 and M4 to operate differentially.

Consequently, as shown in FIG. 4, according to the quadrature voltage controlled oscillator of the invention, the first to fourth signals V1,V2,V3 and V4 exhibit a phase difference of 90 degree so that the first and second common nodes N1 and N2 are differential from each other.

As just described above, the invention overcomes a conventional problem of phase noises which are caused by phase shifting of coupled transistors. Also, to eliminate phase noises, the invention reduces the number of the inductors, which are cumbersome for IC integration.

As set forth above, the invention is applicable to an RF transceiver performing quadrature modulation/demodulation, in which a common node is configured as an inductor to differentiate a quadrature signal. This obviates a need for an active device, thereby improving phase noise properties and lowering power consumption.

That is, with absence of the active device, there is no increase in phase noises and no need for additional transistors. Thus no additional power is consumed and oscillation is carried out more accurately at peak impedance of an LC tank, thereby preventing increase in phase noises. Moreover, an additional inductor can be externally installed to enhance IC integration.

While the present invention has been shown and described in connection with the preferred embodiments, it will be apparent to those skilled in the art that modifications and variations can be made without departing from the spirit and scope of the invention as defined by the appended claims.

What is claimed is:

1. A quadrature voltage controlled oscillator comprising:
a first oscillator including a first resonant circuit for generating a preset first resonant frequency and a first pair of cross-coupled transistors for supplying energy to the first resonant frequency to generate first and second signals having a phase difference of 180 degree;
a second oscillator including a second resonant circuit for generating a preset second resonant frequency and a second pair of cross-coupled transistors for supplying energy to the second resonant frequency to generate third and fourth signals having a phase difference of 180 degree;
a first current source connected between a first common node of the first cross-coupled transistor pair and a ground;
a second current source connected between a second common node of the second cross-coupled transistor pair and the ground; and
a differential load connected between a third common node of the first and second current sources and the ground.

2. The quadrature voltage controlled oscillator according to claim 1, wherein the first resonant circuit comprises:
a first inductor part including two inductors each having first and second ends, the first ends connected in parallel to a supply voltage terminal; and
a first capacitor part for supplying capacitance in response to a first controlled voltage and cooperating with the first inductor part to generate the first resonant frequency, the first capacitor connected to the second ends of the respective inductors of the first inductor part.

3. The quadrature voltage controlled oscillator according to claim 2, wherein the first current source comprises a Metal Oxide Semiconductor (MOS) transistor having a gate for receiving a first control signal, a drain connected to the first common node and a source connected to the third common node, the MOS transistor controlling current flowing between the drain and the source in response to the first control signal.

4. The quadrature voltage controlled oscillator according to claim 1, wherein the second resonant circuit comprises:
a second inductor part including two inductors each having first and second ends, the first ends connected in parallel to a supply voltage terminal; and
a second capacitor part for supplying capacitance in response to a second control voltage and cooperating with the second inductor part to generate the second resonant frequency, the second capacitor connected to the second ends of the respective inductors of the second inductor part.

5. The quadrature voltage controlled oscillator according to claim 4, wherein the second current source comprises an MOS transistor having a gate for receiving a second control signal, a drain connected to the second common node and a source connected to the third common node, the MOS transistor controlling current flowing between the drain and source in response to the second control signal.

6. The quadrature voltage controlled oscillator according to claim 1, wherein the differential load comprises an inductor for inducing an alternating current.

7. The quadrature voltage controlled oscillator according to claim 6, wherein the first and second signals of the first oscillator have a phase difference of 90 degree with respect to the third and fourth signals of the second oscillator, respectively.

8. The quadrature voltage controlled oscillator according to claim 3, wherein the first current source further comprises a resistor connected to the gate of the MOS transistor.

9. The quadrature voltage controlled oscillator according to claim 5, wherein the second current source further comprises a resistor connected to the gate of the MOS transistor.

10. The quadrature voltage controlled oscillator according to claim 2, wherein the first capacitor part comprises two capacitors connected in series to the second ends of the respective inductors of the first inductor part,
wherein the capacitors of the first capacitor part supply capacitance which is variable according to the first control voltage.

11. The quadrature voltage controlled oscillator according to claim 4, wherein the second capacitor comprises two capacitors connected in series to the second ends of the respective inductors of the second inductor part,
wherein the capacitors of the capacitor part supply capacitance which is variable according to the second control voltage.
